(19) United States
(12) Patent Application Publication
(10) Pub. No.: US 2026/0210506 A1
(43) Pub. Date: Jul. 23, 2026

(54) OPTOELECTRONIC DEVICE OF THE LED (LIGHT EMITTING DIODE) TYPE AND PRODUCTION METHOD OF SAID LED

(71) Applicant: LEDWORKS S.R.L., Mestrino (PD) (IT)

(72) Inventors: Andrea Tellatin, Milano (IT); Marco Franciosa, Milano (IT); Giorgio Gatto, Milano (IT)

(73) Assignee: LEDWORKS S.R.L., Milano (IT)

(21) Appl. No.: 19/143,010

(22) PCT Filed: Dec. 27, 2023
(86) PCT No.: PCT/IB2023/063264

§ 371 Date: Jun. 25, 2025

(30) Foreign Application Priority Data
Dec. 27, 2022 (IT) 102022000026841

(51) Int. Cl. F21V 7/04; F21V 23/00; F21Y 115/10

(52) U.S. Cl. CPC F21S 4/10; F21V 3/049; F21V 7/0091; F21V 23/001; F21Y 2115/10

(57) ABSTRACT

Optoelectronic device of the LED (light emitting diode) type, comprising a light source (1) comprising a flat emission surface (10), which light source (1) is contained within an outer casing (2), configured to allow the passage of at least part of a light beam generated by the light source (1), there being at least one power cable (3) of said light source (1) connected to an electrical power source.

Said light source (1) is directly connected to said power cable (3), said outer casing (2) identifying a transmission channel (20) of said light beam, said transmission channel (20) and said light source (1) being configured so as to identify a scattering point of the light beam positioned at an end of said transmission channel (20), said scattering point and said light source (1) being spaced apart.

The present invention relates to an optoelectronic device of the LED (light emitting diode) type, comprising a light source with a flat emission surface, which light source is contained within an outer casing, configured to allow the passage of at least part of a light beam generated by the light source.

At least one power cable of the light source is also present, which is connected to an electrical power source.

That described above is the common configuration of lighting elements known in the state of the art, commonly used within LED strings used, for example, in Christmas-type light decorations.

In such applications, LEDs of the addressable type are commonly used, i.e., LEDs which are configured so as to receive instructions for driving the light intensity to be emitted, together with further command data, sent by a control unit connected to said LEDs, data and current transmitted through the power cable.

The well-known RGB (Red, Green and Blue) LEDs belong to such a category, i.e., LEDs which have three emitters, in particular an emitter adapted to emit a red light, an emitter adapted to emit a green light and an emitter adapted to emit a blue light.

The outer casing allows the mixing of the colours emitted by the three emitters, so as to obtain different possible colours.

The LED strings known in the state of the art have a plurality of LEDs with two metal pins connected in series to the power cable, consisting of three metal conductors twisted together in a helical manner and covered by an insulating sheath.

Furthermore, the outer casing comprises a heat-shrinkable tube which covers and hides the two metal pins and which is fixed to the LED lens.

The configuration just described gives the LED strings known in the state of the art an immediately recognizable appearance, which associates such LED strings with Christmas decorations, so that users immediately recognize such LED strings to use them to decorate their trees.

Furthermore, since such LED strings have been known and used for several years in the market, the methodology and machinery are consolidated and optimized to make production more efficient.

However, the strings known in the art have several disadvantages.

In fact, the production of LED strings does not allow the creation of devices which have a high degree of protection of the LEDs in atmospheric conditions, as it is currently possible to obtain a level of protection which meets the IP44 requirements, but does not meet the more stringent requirements, of the IP64 or IP68 type, making it difficult to install the LED strings known in the state of the art in outdoor environments, regardless of the atmospheric conditions.

Furthermore, the construction features of the LED strings known in the state of the art do not allow a complete automation of production, making it necessary to produce in countries which have a low labour cost.

However, the countries commonly used for low labour cost are experiencing a period of increasing costs related to materials, which causes an inevitable increase in production costs.

Furthermore, in such countries it is difficult to meet all the requirements necessary to maintain a certain degree of secrecy of the technology to be produced, risking the loss of industrial secrets.

Logistical disadvantages must also be considered in envisaging production in countries with low labour costs, as the time and costs for moving goods from the production country to the countries in which to sell such goods have increased, with continuous increases in duties and customs taxes.

Finally, the LED strings known in the state of the art also have commercial disadvantages.

In fact, precisely because of the production features which make all the strings similar, companies struggle to place products on the market which can be identified as unique and immediately traced back to the company.

Furthermore, a factor linked to production in countries with low labour costs, the products will not be able to have the “made in Italy” or “made in USA” label, with obvious commercial repercussions.

There is therefore a need not met by the devices known in the state of the art to realise the disadvantages set out above related to the LED strings known in the state of the art.

The present invention achieves the above purposes by manufacturing a device as described above, in which the light source is connected directly to the power cable.

Furthermore, the outer casing identifies a light beam transmission channel and the transmission channel and the light source are configured so as to identify a light beam scattering point positioned at an end of the transmission channel, the scattering point and the light source being spaced apart.

As will be evident from the illustration of some embodiments and from the production method described below, the light source can be automatically welded to the power cable, without the need for human intervention.

The light source is thus welded to the power cable and is arranged on the plane of the power cable.

Given the positioning of the light source, the problem of light transmission for outer casings with “elongated” shapes, i.e., with a scattering zone far from the light source, arises.

For this reason, the device object of the present invention has a transmission channel configured to generate a light beam scattering point which is spaced apart with respect to the light source.

Different transmission channel configurations can be envisaged to accomplish the above purpose.

For example, it is possible to envisage exploiting the rays of the light beam directed towards the scattering point.

However, in order to exploit most of the rays of the light beam, the present invention sets out to recreate the behaviour of optical fibres, i.e., to exploit the bounce of the rays within the outer casing.

For this reason, preferably the outer casing consists, at least in part, of transparent material.

In fact, in the case of transparent material, if the angle of inclination of the rays with respect to the flat emission surface is greater than a certain threshold value, a total reflection of the ray occurs, without any transmission, when the ray, crossing the transparent walls, meets the air of the environment surrounding the outer casing.

It is therefore possible to envisage that the outer casing consists only in part of transparent material, and in part of material with features which do not allow the passage of light, such as black plastic material.

According to a possible embodiment, the outer casing is made of transparent material having features of purity, i.e., it consists of a homogeneous material of defined and constant composition.

“Pure” materials, i.e., materials consisting of pure substances, are homogeneous systems of defined and constant composition, characterised by specific chemical-physical properties.

Thereby, the outer casing behaves just like an optical fibre, to maximize the transfer of light.

In fact, light propagates in a vacuum at a constant speed c. Light also propagates in other media, such as air, water and glass. However, the atoms of the material partly absorb it, partly re-emit it and partly scatter it. Therefore, the speed of light in a medium other than a vacuum is less than c and its value depends on the nature of the material.

When light strikes the surface separating two transparent materials, it typically splits into two parts: one part is reflected with a reflection angle equal to the angle of incidence, and one part continues to propagate beyond the separation surface.

Therefore, it is important that the material is pure, i.e., always the same, so that the beam never encounters a different material and never gives rise to a reflection process.

If the outer casing consists of pure material, a continuous change of material is avoided during the propagation of the light beam, to avoid frequent refraction and reflection phenomena.

According to a preferred variant embodiment, the outer casing mainly consists of a transparent material.

The outer casing further comprises an opaque part placed at the scattering point.

In combination with such a variant, preferably the light source comprises one or more emitters, there being one or more barrier elements, configured so as to intercept the transmission of the rays belonging to the light beam which scatter inside the transmission channel with an inclination lower than a certain threshold value with respect to the flat emission surface.

Therefore, the barrier elements intercept the rays which would not be reflected by the walls of the outer casing.

Preferably, the barrier elements consist of reflective material, so as to reflect such rays and make them bounce inside the outer casing, so that such rays can reach the scattering point.

The barrier elements, thanks to the reflective surfaces, could not only reflect, but also change the angle of reflection of the rays belonging to the generated light beam.

The change in the angle of reflection allows the rays to be directed towards the scattering point and helps to limit the dispersion of the beam.

As will be apparent from the illustration of some exemplary embodiments, the aesthetic effect obtained by the above-described configuration of the light transmission channel is particularly pleasant and allows to obtain a point of light at the light source and a point of light scattering, which is more intense than the point of light at the light source.

Such a feature allows to give an appearance which is very similar to the LEDs known in the state of the art, but with an aesthetic characteristic which is peculiar to the device object of the present invention, so as to allow a user to immediately recognize such a device, despite the fact that it can be associated with the LEDs known in the state of the art.

Furthermore, the particular optical configuration described allows the light source to be kept at the level of the power cable, so as to be welded to the latter, but, at the same time, to scatter the light from a point which is spaced apart with respect to the light source, so as to have light characteristics like the LEDs known in the state of the art, but with the possibility of being produced automatically.

Advantageously the power cable comprises at least two flat power conductors coated with an outer sheath.

The outer sheath identifies a housing seat for each conductor.

The presence of two housing seats in a single sheath strongly limits the relative movement between the two conductors, avoiding the risk of one of the conductors accidentally detaching from the light source.

Obviously, depending on the type of light source used, it will be possible to envisage two, three or more conductors.

In view of the advantages discussed above related to the device, it is specified that the present invention also relates to a method for producing an optoelectronic device of the LED (light emitting diode) type.

The method object of the present invention can be used for the production of any LED.

Preferably, however, the optoelectronic device has one or more of the features, taken alternatively or in combination, described above.

In particular, the method covered by the present invention envisages the following steps:
welding the power cable to the light source, so as to identify a plane on which the cable and the light source lie,
injection moulding the outer casing around the light source.

Both steps indicated above are carried out automatically.

To carry out such steps automatically, it is possible to provide machinery known in the state of the art, an assembly machine, such as a machine of the SMT (surface mount technology) type for welding the cable to the light source and for directing the light source, is a vertical PVC injection machine for making the outer casing, built around the light source.

Thanks to the automation of the production steps of the device object of the present invention, the method allows to obtain any shape of the outer casing, with a simple programming of the injection moulding.

Furthermore, the device produced by the method object of the present invention allows to obtain a high degree of protection, up to meeting the IP65 requirements.

Lastly, the fully automatic creation of optoelectronic devices allows to move the production of the devices themselves from countries which have a low labour cost, solving all the disadvantages set out above in terms of costs, logistics and technology protection.

The shipping costs of the materials are also reduced, as the shipments will be limited only to the components, to be purchased separately, for assembling and producing the device.

Last but not least, there is the commercial and marketing advantage of being able to affix the words “made in Italy” or “made in USA”, depending on where the device is produced.

As anticipated, one of the objects of the present invention is to provide a peculiar and recognizable optoelectronic device, but which is easily associated with the categories of LED strings known in the state of the art.

For this reason, a variant embodiment of the method of the present invention has a step following the welding step, which envisages coating the conductors constituting the power cable, with an external sheath, so as to identify a housing seat for each sheath.

There is also a subsequent twisting step of the housing seats on themselves.

The twisting step gives the power cable the classic helical extension of the power cables of the LED strings known in the state of the art.

Lastly, the invention relates to a lighting device comprising a plurality of lighting elements electrically connected in series to each other.

In particular, each lighting element is made according to one or more of the features described above and related to the optoelectronic device object of the present invention.

These and further objects of the present invention are achieved by a device and a method according to the appended independent claims and the sub-claims.

Optional features of the device of the invention are contained in the attached dependent claims, which form an integral part of the present disclosure.

These and other features and advantages of the present invention will become clearer from the following disclosure of some embodiment examples illustrated in the accompanying drawings in which:

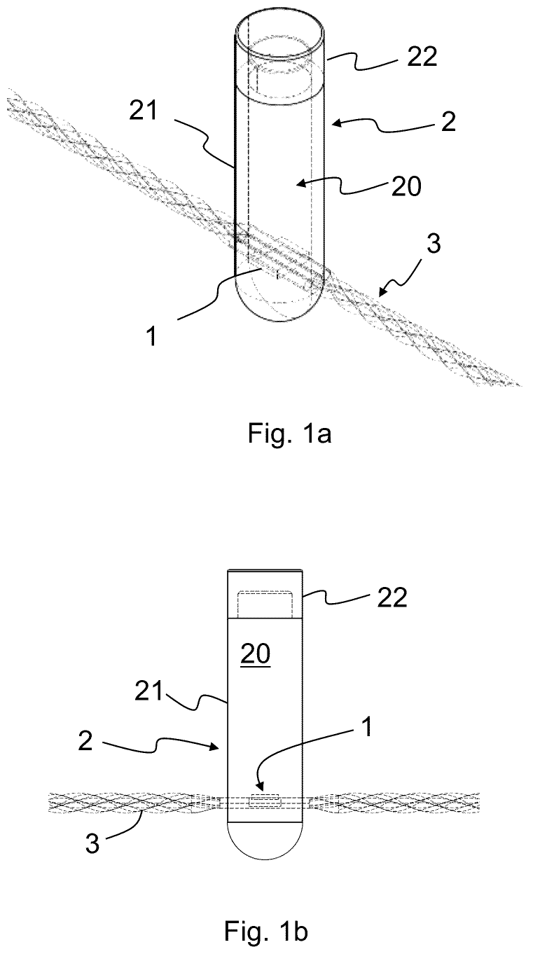

FIGS. 1a and 1b show two views of a possible embodiment of the device object of the present invention;

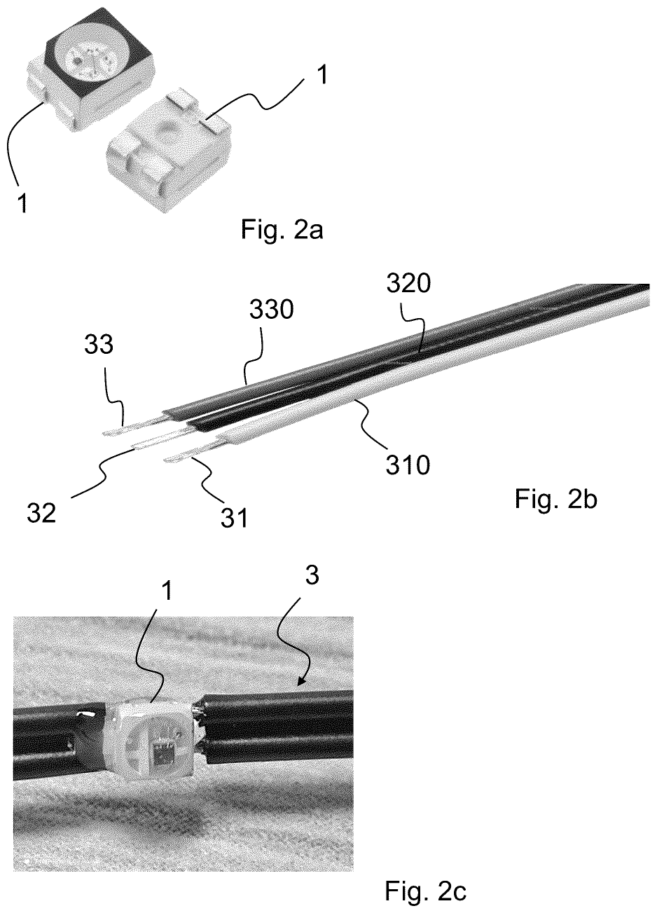

FIGS. 2a to 2c show some details of a possible embodiment of the device object of the present invention;

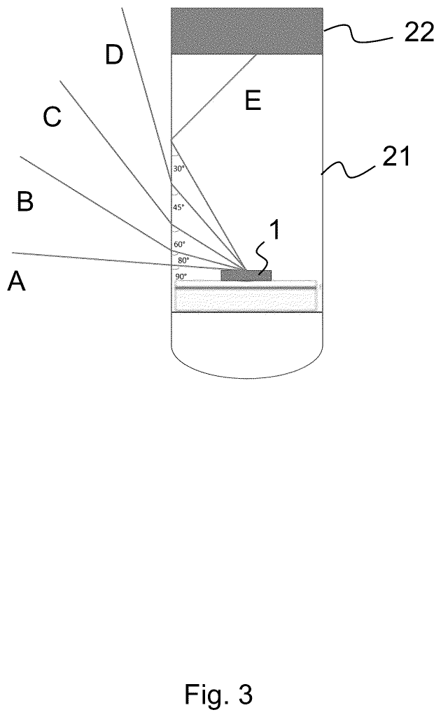

FIG. 3 shows an exemplary diagram of the operation of the light beam scattering within the device object of the present invention;

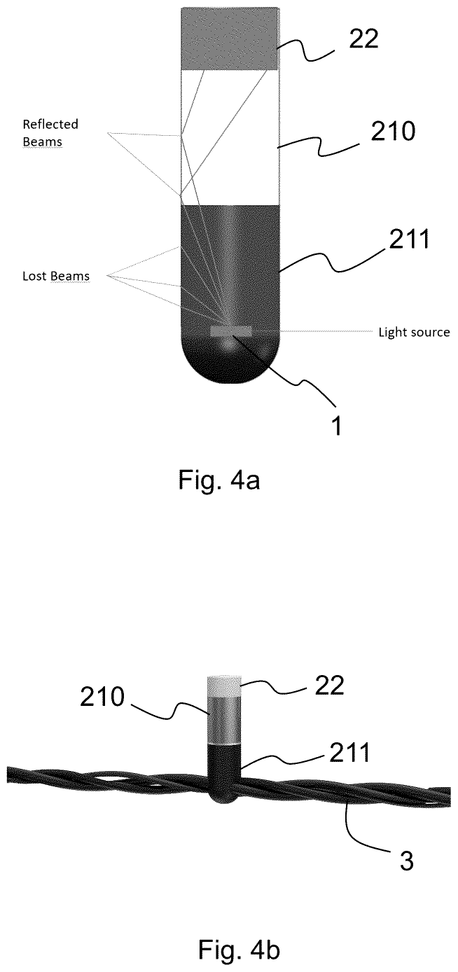

FIGS. 4a and 4b show two views of a possible embodiment of the device object of the present invention;

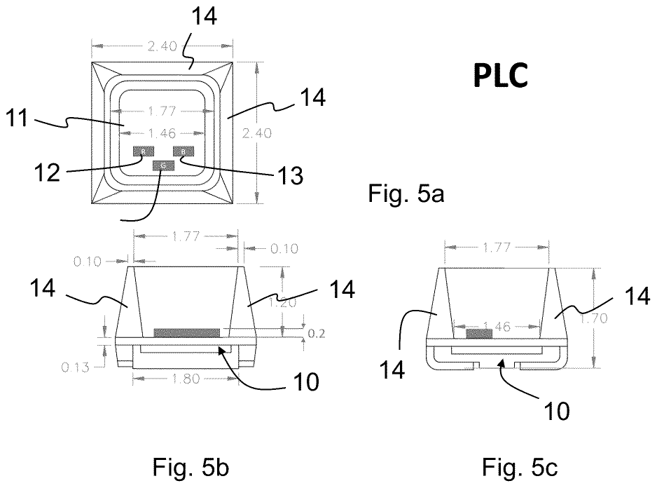

FIGS. 5a to 5c show three views of a variant embodiment of the light source belonging to the device object of the present invention;

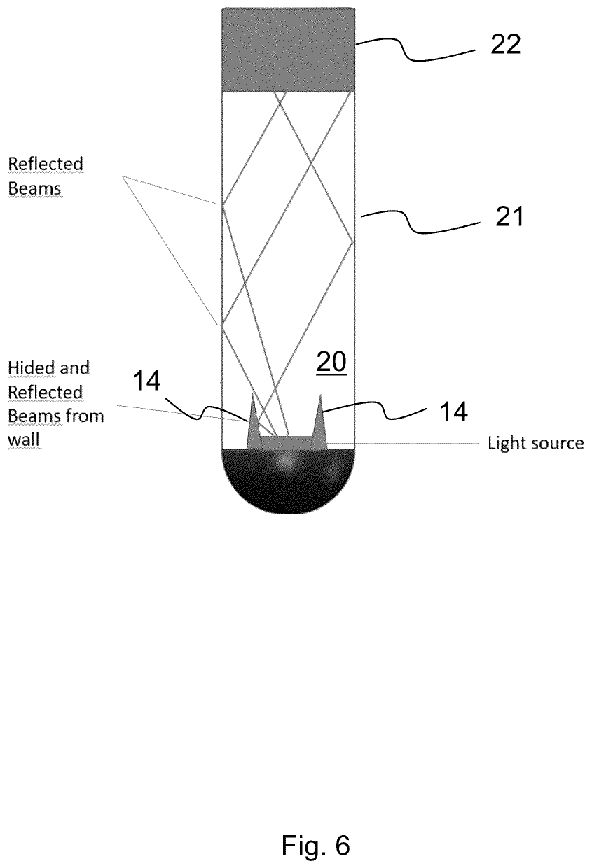

FIG. 6 shows the view of an embodiment of the device object of the present invention in which the light source according to FIGS. 5a to 5c is mounted;

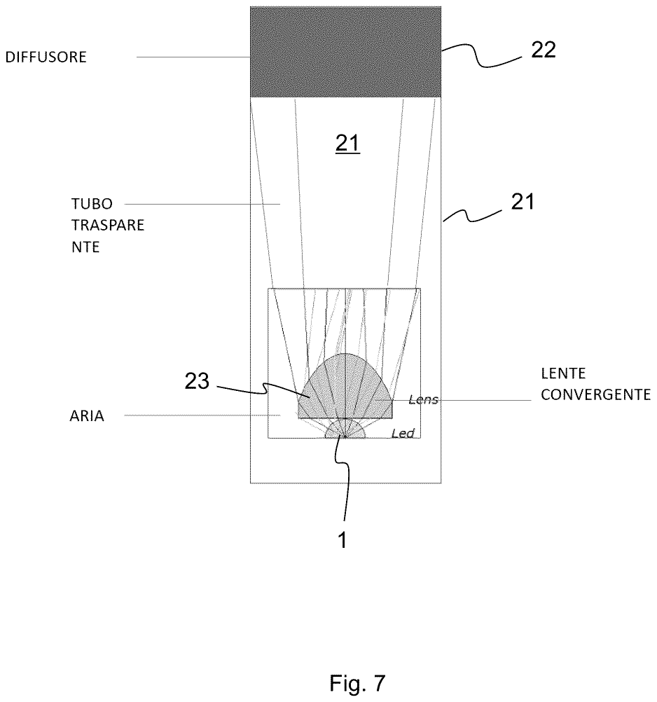

FIG. 7 shows a concept diagram of a possible embodiment of the device object of the present invention;

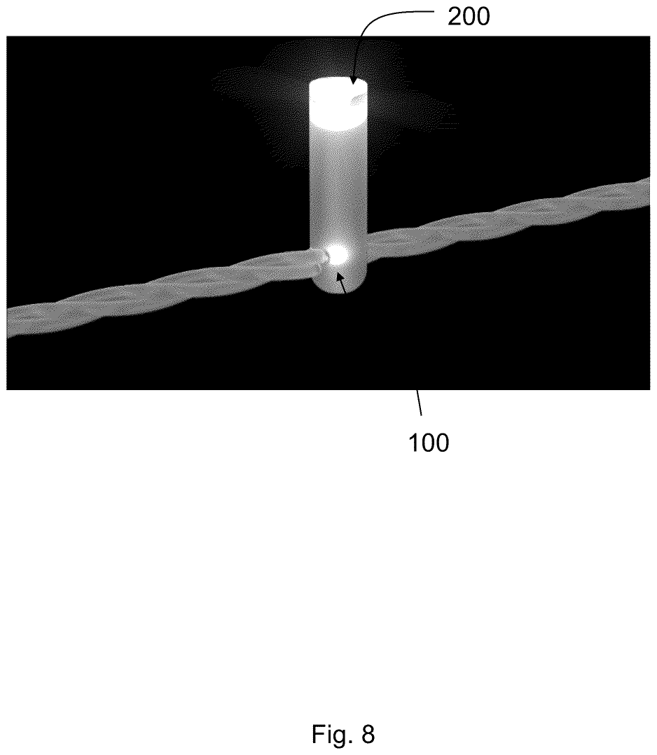

FIG. 8 shows a further view of the device object of the present invention.

It is specified that the figures attached to the present patent application show only some possible embodiments of the optoelectronic device object of the present invention to better understand its described advantages and features.

Such embodiments are therefore to be understood as purely illustrative and not limiting to the inventive concept of the present invention, namely that of making an optoelectronic device of the LED type and a string of LEDs which can be produced in a completely automatic manner, having peculiar and specific aesthetic features, but which, at the same time, can associate the device and the LED string with the strings known in the state of the art.

In particular, the figures show an optoelectronic device with an outer casing made in the form of a tubular element, but it will be clear how any shape of the outer casing can be provided.

With particular reference to FIGS. 1a and 1b, two views of a possible form of the optoelectronic device of the LED (light emitting diode) type object of the present invention are shown.

The device has a light source 1 comprising a flat emission surface and contained within an outer casing 2, configured to allow the passage of at least part of a light beam generated by the light source 1.

There is also a power cable 3 of the light source 1, connected to an electrical power source (not shown in the figures).

The light source 1 is directly connected to the power cable 3.

The outer casing identifies and delimits a light beam transmission channel 20.

As will be apparent from the following description, the transmission channel 20 and the light source 1 are configured to identify a light beam scattering point positioned at an end of the transmission channel 20, the scattering point and the light source 1 being spaced apart.

As previously described, the outer casing 2 consists of a tubular element which envisages a body portion 21 and a scattering portion 22.

According to the illustrated variant, the scattering portion 22 corresponds to the scattering point, positioned in the upper end of the outer casing.

According to the variant shown in the figures, the light source 1 and the scattering point are located at opposite terminals of the outer casing.

With reference to the figures, the light source 1 is positioned in the lower end of the outer casing, on the same plane as the power cable 3, while the scattering point is positioned at the scattering portion 22, i.e., the upper end of the outer casing 2.

Preferably, the light source 1 consists of an LED of the SMD type, which is welded directly to the power cable 3, as shown in FIGS. 2a and 2c.

As shown in FIG. 2b, the power cable advantageously consists of three flat conductors 31, 32, 33 coated by an outer sheath of plastic material, which identifies three housing seats, respectively, 310, 320, 330, which separately coat the three flat conductors 31, 32 and 33.

The three conductors 31, 32 and 33 are therefore electrically isolated from each other, but the three housing seats are mechanically fixed to each other, so that the flat conductors 31, 32 and 33 do not have relative movement with each other.

As described above and as shown in FIGS. 1a and 1b, the flat conductors 31, 32 and 33, after being welded to the light source 1, are twisted on themselves in a helical manner.

Obviously, it is possible to envisage a lower or higher number of flat conductors, based on the type of light source 1 used.

FIG. 3 is shown to explain the operation of the light source 1 inside the outer casing 2.

The light source 1 generates a light beam which, for illustrative simplicity, comprises a plurality of light rays A, B, C, D, E inclined differently with respect to the emission surface of the light source 1.

When the rays A, B, C, D and E cross different materials, such as the interface between the outer surface of the outer casing 2 and the environment external thereto, they are divided into two parts, of which a reflected part, which bounces at the same angle and a transmitted part which crosses the walls of the outer casing and changes inclination.

In the case of completely transparent material, if the ray inclination angle with respect to the emission surface of the light source 1 is less than a certain threshold value, the transmission part is zero.

In the case of a casing made of completely transparent material, the rays having an inclination greater than the threshold value, in the interface area between the outer surface of the outer casing 2 and the environment outside the casing itself, bounce and are directed towards the scattering point, i.e., the scattering portion 22, preferably made of opaque material.

According to the experimental data, such a threshold value is about 60°.

With reference to FIG. 3, the rays A, B, C and D, which have inclinations less than 60°, do not bounce and are transmitted into the surrounding environment, while the ray E, with an inclination greater than 60°, bounces and is directed towards the scattering point.

It follows that only the ray E will have a contribution to the lighting intensity of the device object of the present invention.

According to a first embodiment, shown in FIGS. 4a and 4b, the main body portion 21 of the outer casing 2, consists of a part in transparent material, indicated with 210 and a part in black plastic material, or material coated with a dark paint, indicated with 211.

The part 211 extends along the body of the outer casing 2 for a certain length.

The length is adjusted based on the point of incidence of the rays, i.e., it must be equal to or slightly less than the point of incidence of the ray which has an inclination of 60° with respect to the emission surface of the light source 2.

Such a configuration allows to obscure the scattering in the external environment of the rays which are not bounced towards the scattering point, i.e., which have inclinations with respect to the emission surface of the light source 1 of a value lower than the threshold value.

According to a preferred embodiment, the device object of the present invention instead aims to also exploit the contribution which such rays can make to the light intensity generated.

To achieve such an aim, the device object of the present invention envisages making a modification to the light source 1, as shown in FIGS. 5a to 5c.

With particular reference to the figures, the light source 1 has an emission surface 10 on which three emitters, 11, 12 and 13, corresponding to the red, green and blue emitters mounted on the LEDs known in the art, are mounted.

As in the case of the SMD LED, the emission surface 10 can comprise an electronic board aimed at controlling the operation of the LED itself.

The light source 1 also has barrier elements 14, mounted laterally with respect to the emission surface 10.

The barrier elements 14 preferably consist of a concave element which completely surrounds, on all sides, the light source 1, creating a sort of parabola around the emission surface.

Advantageously, the barrier elements 14 have reflective inner surfaces 141, so as to capture and reflect the rays belonging to the light beam generated by the light source 1.

Preferably, the barrier elements 14 have a height such as to intercept only a part of the rays, i.e., all the rays which have a lower inclination with respect to the threshold value described above.

Thereby, even the rays which in the previous variant did not contribute to increasing the light intensity, are reflected and projected in the direction of the scattering point.

Such a configuration is shown in FIG. 6: all the rays belonging to the light beam generated by the light source 1 are directed towards the scattering point, i.e., towards the scattering portion 22, both those which have an inclination greater than the threshold value, and those which have lower inclinations, thanks to the presence of the barrier elements 14.

In this case, the outer casing is made of completely transparent material, i.e., the portion of the main body 21 is completely made of transparent material, while the scattering portion 22 is made of opaque material.

As described above, the outer casing is preferably made through an injection moulding, which in this case occurs in two successive steps, one to make the body in transparent material and one to make the opaque scattering portion.

The direction of the light rays towards the scattering point can be obtained in different ways.

A first method has been described in the previous figures thanks to the presence of the reflective walls of the barrier elements.

A second mode is shown in FIG. 7, in which the barrier elements comprise a lens 23 designed to intercept the light rays generated by the light source 1 and to modify the angle of inclination with respect to the flat emission surface, so as to converge such rays towards the scattering point 22.

In practice, the lens 23 increases the angle of inclination of the rays with respect to the flat emission surface, i.e., it decreases the angle of incidence of the rays with respect to the walls of the outer casing 2.

Preferably, there is air above the lens 23 to obtain a change in the propagation medium of the light rays and obtain the effect of angle and refraction change.

Thanks to the presence of the lens 23, the amplitude of the light beam is narrowed, so that all the rays of the beam converge towards the scattering point 22.

FIG. 8 shows a possible light effect which is obtained with the embodiment of the device described above.

As is evident, the device object of the present invention provides two light points, a first light point 100 at the light source and a second light point 200 at the scattering point.

Based on the optical features described, advantageously, the light point 200 will have a greater light intensity with respect to the light point 100.

While the invention is subject to various modifications and alternative constructions, some preferred embodiments have been shown in the drawings and described in detail.

It should be understood, however, that there is no intention to limit the invention to the specific illustrated embodiment but, on the contrary, the aim is to cover all the modifications, alternative constructions and equivalents falling within the scope of the invention as defined in the claims.

The use of “for example”, “etc.”, “or” refers to non-exclusive non-limiting alternatives, unless otherwise stated.

The use of “includes” means “includes but is not limited to”, unless otherwise stated.

1. Optoelectronic device of the LED (light emitting diode) type, comprising a light source comprising a flat emission surface, which light source is contained within an outer casing, configured to allow the passage of at least part of a beam of light generated by the light source,
there being at least one power cable of said light source connected to an electrical power source,
characterized in that
said light source is directly connected to said power cable, said outer casing identifying a transmission channel of said light beam,
said transmission channel and said light source being configured to identify a light beam scattering point positioned at an end of said transmission channel, said scattering point and said light source being spaced apart.

2. Device according to claim 1, wherein the outer casing consists of a tubular element, arranged with its own longitudinal axis perpendicularly with respect to said flat emission surface, the scattering point being positioned at the end of said tubular element.

3. Device according to claim 2, wherein said light source is positioned at the end of the tubular element opposite the scattering point.

4. Device according to claim 1, wherein said outer casing consists, at least in part, of transparent material, said outer casing having an opaque zone at the scattering point.

5. Device according to claim 4, wherein said transparent material part consists of a homogeneous material of defined and constant composition.

6. Device according to claim 1, wherein said light source comprises one or more emitters there being one or more barrier elements, which barrier elements are configured so as to intercept the transmission of the rays belonging to the light beam which scatter within the transmission channel with an inclination below a certain threshold value with respect to the flat emission surface.

7. Device according to claim 6, wherein said barrier elements have reflective walls to reflect, in the direction of the scattering point, the rays belonging to the light beam which scatter within the transmission channel with an inclination below a certain threshold value with respect to the flat emission surface.

8. Device according to claim 1, wherein said power cable comprises at least two flat power conductors coated by an outer sheath, which outer sheath identifies a housing seat for each conductor.

9. Method for producing an optoelectronic device of the LED (light emitting diode) type according to claim 1, wherein the following steps are envisaged:
welding the power cable to the light source, so as to identify a plane on which the power cable and the light source lie,
injection moulding the outer casing around the light source,
the welding step and the injection moulding step being carried out automatically.

10. Method according to claim 9, wherein a step is envisaged which includes coating the at least two conductors with an outer sheath, so as to identify at least two corresponding housing seats, a step of twisting said housing seats on themselves being subsequently envisaged.

11. Lighting device comprising a plurality of lighting elements electrically connected in series to each other,
characterized in that
said lighting elements consist of an optoelectronic device of the LED (light emitting diode) type made according to one or more of claim 1.
